(19) United States
(12) Patent Application Publication
(10) Pub. No.: US 2021/0264779 A1
(43) Pub. Date: Aug. 26, 2021

(54) Vehicle Identification System

(71) Applicant: Frogparking Limited, Palmerston North (NZ)

(72) Inventor: Donald H. Sandbrook, Palmerston North (NZ)

(73) Assignee: Frogparking Limited

(21) Appl. No.: 16/800,466

(22) Filed: Feb. 25, 2020

(51) Int. Cl. G08G 1/065; G06K 9/20; G06K 9/00; G06K 9/03

(52) U.S. Cl. CPC G08G 1/065; G06K 9/209; G06K 2209/15; G06K 9/036; G06K 9/00785

(57) ABSTRACT

A vehicle identification system for detecting a vehicle entering a point of interest, capturing an image of the vehicle, and extracting an identifying feature such as a license plate from the captured image. The vehicle identification system generally includes a sensor oriented towards a point of interest. Upon detection of a vehicle entering the point of interest, a camera will be directed to capture an image of the vehicle. The captured image will be processed so as to extract an identifying feature of the vehicle, such as a license plate. The system is configured to prevent false positives by rejecting extracted images which are obscured or which represent vehicles which have already been detected previously. The collected information may be used for many purposes, such as parking guidance, car counting, parking space availability, and vehicle location.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND

### Field

Example embodiments in general relate to a vehicle identification system for detecting a vehicle entering a point of interest, capturing an image of the vehicle, and extracting an identifying feature such as a license plate from the captured image.

### Related Art

Any discussion of the related art throughout the specification should in no way be considered as an admission that such related art is widely known or forms part of common general knowledge in the field.

Automated license plate recognition has been used for many years. However, image processing is complicated by nature and thus highly susceptible to errors or miscalculations. For example, factors such as sunlight glare, passing vehicles or pedestrians, or other factors which would inhibit the identification of a license plate may have a drastic negative impact on the reliability of systems using previous methods of automated license plate recognition.

Such a higher error rate introduces unreliability into the system which can be unacceptable for certain applications, such as for traffic counting or identifying vehicles in parking spaces. Systems that rely purely on vehicle or number plate recognition for parking availability have been known for their poor accuracy. By combining the capture of images with space-specific sensory information, the reliability of such systems can be greatly improved to overcome the shortcomings of existing, prior art license plate recognition systems.

### SUMMARY

An example embodiment is directed to a vehicle identification system. The vehicle identification system includes a sensor oriented towards a point of interest. Upon detection of a vehicle entering the point of interest, a camera will be directed to capture an image of the vehicle. The captured image will be processed so as to extract an identifying feature of the vehicle, such as a license plate. The system is configured to prevent false positives by rejecting extracted images which are obscured or which represent vehicles which have already been detected previously. The collected information may be used for many purposes, such as parking guidance, car counting, parking space availability, and vehicle location.

There has thus been outlined, rather broadly, some of the embodiments of the vehicle identification system in order that the detailed description thereof may be better understood, and in order that the present contribution to the art may be better appreciated. There are additional embodiments of the vehicle identification system that will be described hereinafter and that will form the subject matter of the claims appended hereto. In this respect, before explaining at least one embodiment of the vehicle identification system in detail, it is to be understood that the vehicle identification system is not limited in its application to the details of construction or to the arrangements of the components set forth in the following description or illustrated in the drawings. The vehicle identification system is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Example embodiments will become more fully understood from the detailed description given herein below and the accompanying drawings, wherein like elements are represented by like reference characters, which are given by way of illustration only and thus are not limitative of the example embodiments herein.

FIG. 1A is a side view of a vehicle identification system monitoring a point of interest in accordance with an example embodiment.

FIG. 1B is a top view of a vehicle identification system monitoring a point of interest in accordance with an example embodiment.

FIG. 2 is a perspective view of a parking garage utilizing a vehicle identification system in accordance with an example embodiment.

FIG. 3 is a perspective view of a housing of a vehicle identification system in accordance with an example embodiment.

FIG. 4A is a side view of a vehicle identification system monitoring multiple points of interest in accordance with an example embodiment.

FIG. 4B is a top view of a vehicle identification system monitoring multiple points of interest in accordance with an example embodiment.

FIG. 5 is a perspective view of a parking garage utilizing a vehicle identification system in accordance with an example embodiment.

FIG. 6 is a top view of a vehicle identification system monitoring multiple points of interest in accordance with an example embodiment.

FIG. 7 is a perspective view of a housing of a vehicle identification system in accordance with an example embodiment.

FIG. 8 is a block diagram of a vehicle identification system in accordance with an example embodiment.

FIG. 9 is a block diagram of a vehicle identification system in accordance with an example embodiment.

FIG. 10 is a block diagram of a vehicle identification system in accordance with an example embodiment.

FIG. 11 is a block diagram of a housing of a vehicle identification system in accordance with an example embodiment.

FIG. 12 is a block diagram of a vehicle identification system in accordance with an example embodiment.

FIG. 13 is a flowchart illustrating the detection of a vehicle and extraction of license plate information of a vehicle identification system in accordance with an example embodiment.

FIG. 14 is a flowchart illustrating communication of data to a control unit a vehicle identification system in accordance with an example embodiment.

FIG. 15 is a flowchart illustrating repeated image captures of a vehicle identification system in accordance with an example embodiment.

FIG. 16 is a flowchart illustrating rejection of a license plate not meeting criteria of a vehicle identification system in accordance with an example embodiment.

FIG. 17 is a flowchart illustrating rejection of duplicate license plates of a vehicle identification system in accordance with an example embodiment.

FIG. 18 is a flowchart illustrating new vehicle arrival detection of a vehicle identification system in accordance with an example embodiment.

FIG. 19 is a flowchart illustrating the display of status of parking spaces in a parking garage of a vehicle identification system in accordance with an example embodiment.

### DETAILED DESCRIPTION

### A. Overview.

The systems and method described herein may be utilized to combine vehicle license plate data and sensory information to determine the location of a vehicle 12, such as within a point of interest such as a parking space 14. One or more sensors 20, 21, such as LIDAR sensors, are adapted to detect a vehicle 12 entering the parking space 14. Upon such a detection, a camera 30 is triggered to capture an image of the vehicle 12. That captured image is then processed, such as by a processing unit 40 locally or a control unit 50 remotely, to extract license plate data such as but not limited to the issuing state or country of the license plate and the license plate number. All such license plate data may be extracted from within the captured image and then communicated, along with the triggering sensor 20, 21 details, via a gateway or direct communication for correlation on a cloud-based system server such as a control unit 50.

The information contained on the control unit 50 may then be used for further analysis and applications. For example, the information could be utilized in connection with “find my car” applications, in which a user will query the system 10 for the location of their vehicle 12. The information could also be utilized for billing purposes, such as by detecting how long a particular vehicle 12 is parked in a specific parking space 14 to determine how much to be billed for parking. The information could also be utilized for parking space 14 monitoring, such as for displaying and monitoring the number of available parking spaces 14 in a given parking garage or lot. The information could also be utilized for guidance within a parking garage or lot, with guidance signs or the like being used to guide a vehicle 12 to an open parking space 14.

An example vehicle identification system 10 generally comprises a sensor 20 oriented towards a point of interest, wherein the sensor is adapted to detect a vehicle 12 positioned at or near the point of interest; a camera 30 oriented such that the point of interest is within a field of view of the camera 30, wherein the camera 30 is adapted to capture an image of the vehicle when the sensor detects the vehicle 12 positioned at or near the point of interest; and a processing unit 40 communicatively connected to the camera 30 and the sensor 20, wherein the processing unit 40 is adapted to extract license plate data from the image of the vehicle 12, wherein the processing unit 40 is adapted to reject the license plate data and instruct the camera 30 to capture an additional image of the vehicle 12 if the license plate data is not extracted from the image of the vehicle 12. A housing 42 may be provided for housing the sensor 20, the camera 30, and the processing unit 40. The sensor 20 may be comprised of a LIDAR sensor. The point of interest may be comprised of a parking space 14. The license plate data may comprise an image of the license plate of the vehicle 12.

The processing unit 40 may be adapted to determine if the vehicle 12 is parked in the point of interest based on a position of the license plate in the image of the license plate. The processing unit 40 may be adapted to reject the license plate image if the license plate image is below a threshold size. A control unit 50 may be communicatively connected to the processing unit 40. The control unit 50 may be remote with respect to the processing unit 40. The control unit 50 may comprise a memory, wherein the processing unit 40 is adapted to communicate the license plate data to the memory of the control unit 50. The control unit 50 may be adapted to identify the vehicle as a new vehicle if the license plate image does not match any of a plurality of reference images, with each of the reference images comprising vehicles 12 which have been previously identified by the control unit 50. The license plate data may comprise a license plate number.

A method of monitoring a parking space with the vehicle identification system 10 may comprise the steps of detecting the vehicle 12 positioned at or near the point of interest by the sensor 20; capturing the image of the vehicle 12 by the camera 30 when the sensor 20 detects the vehicle 12 positioned at or near the point of interest; extracting license plate data from the image of the vehicle 12 by the processing unit 40; and verifying the license plate data based on one or more criteria by the processing unit 40. The license plate data may comprise an identification of the sensor which detected the vehicle. The one or more criteria may be comprised of a size of a license plate image of the license plate data.

In another exemplary embodiment, a vehicle identification system 10 may comprise a first sensor 20 oriented towards a first point of interest, wherein the first sensor 20 is adapted to detect a first vehicle 12 positioned at or near the first point of interest; a second sensor 21 oriented towards a second point of interest, wherein the second sensor 21 is adapted to detect a second vehicle 12 positioned at or near the second point of interest; a camera 30 oriented such that both the first point of interest and the second point of interest are within a field of view of the camera 30, wherein the camera 30 is adapted to capture an image of the first vehicle 12 when the first sensor 20 detects the first vehicle 12 positioned at or near the first point of interest, wherein the camera 30 is adapted to capture an image of the second vehicle 12 when the second sensor 21 detects the second vehicle 12 positioned at or near the second point of interest; and a processing unit 40 communicatively connected to the first sensor 20, the second sensor 21, and the camera 30, wherein the processing unit 40 is adapted to extract a first license plate image from the image of the first vehicle 12 and a second license plate image from the image of the second vehicle 12. The first sensor 20 may be adjacent to the second sensor 21. The first sensor 20, the second sensor 21, and the camera 30 may each be angled downwardly. A housing 42 may be provided for housing the processing unit 40, the first sensor 20, the second sensor 21, and the camera 30.

In another exemplary embodiment, a vehicle identification system 10 may comprise a plurality of sensors 20, 21 each being oriented towards at least one of a plurality of points of interest; a plurality of cameras 30 each being oriented towards at least one of the plurality of points of interest, wherein at least one of the plurality of cameras 30 and at least one of the plurality of sensors 20, 21 is oriented towards each of the plurality of points of interest; a plurality of processing units 40, wherein at least one of the plurality of processing units 40 is communicatively connected to at least one of the plurality of sensors 20, 21 and at least one of the plurality of cameras 30; and a control unit 50 communicatively connected to each of the plurality of processing units 40; wherein each of the plurality of sensors 20, 21 is adapted to detect a vehicle 12 positioned at or near at least one of the plurality of points of interest; wherein each of the plurality of cameras 30 is adapted to obtain an image of the vehicle 12 when one of the plurality of sensors 20, 21 detects the vehicle 12 positioned at or near at least one of the plurality of points of interest; wherein the processing unit 40 is adapted to extract a license plate image from the image of the vehicle 12, wherein the processing unit 40 is adapted to transfer the license plate image of the vehicle 12 to the control unit 50, wherein the control unit 50 is adapted to associate the license plate image of the vehicle 12 with one of the plurality of points of interest.

### B. Sensors.

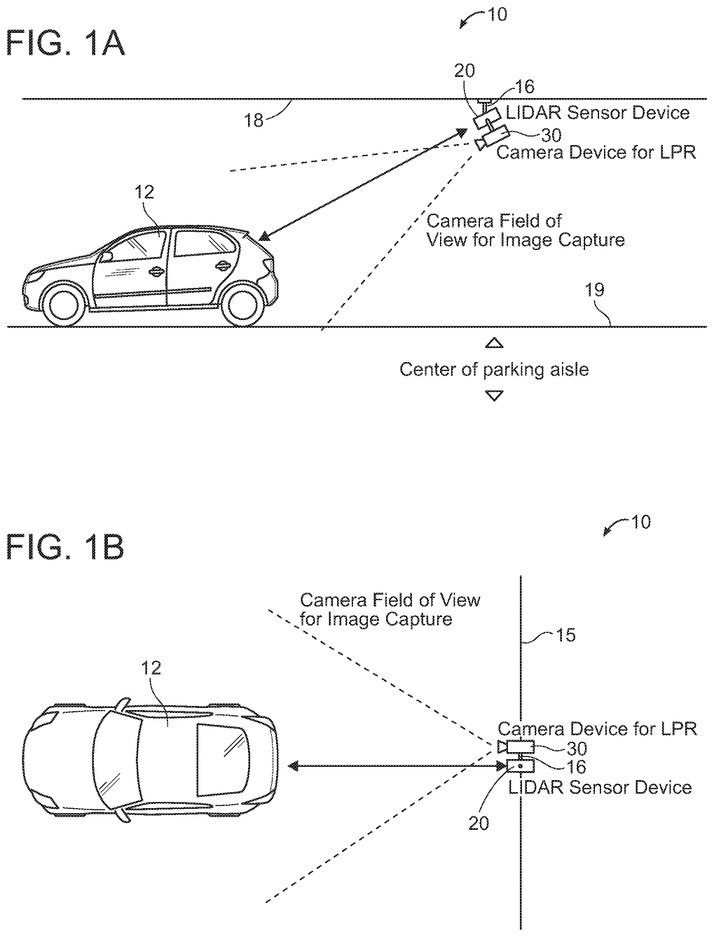

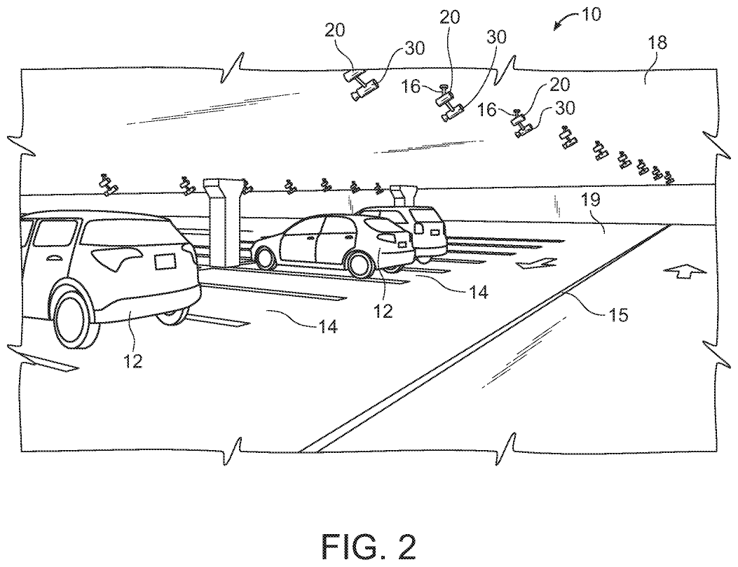

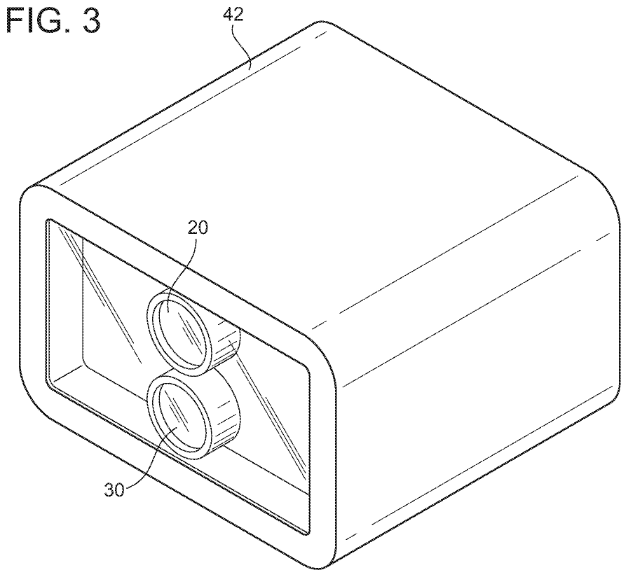

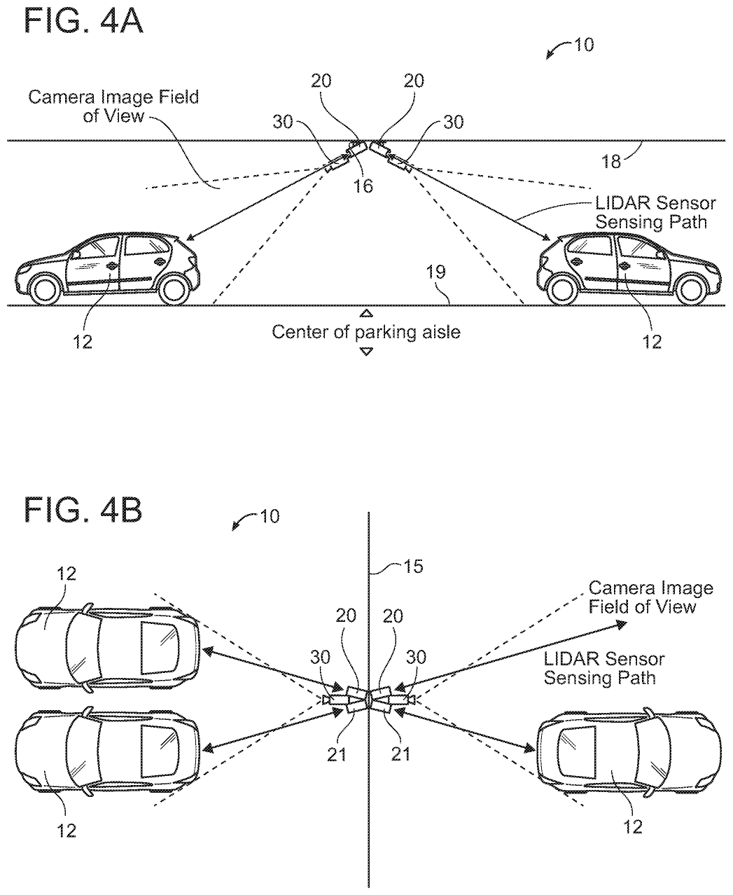

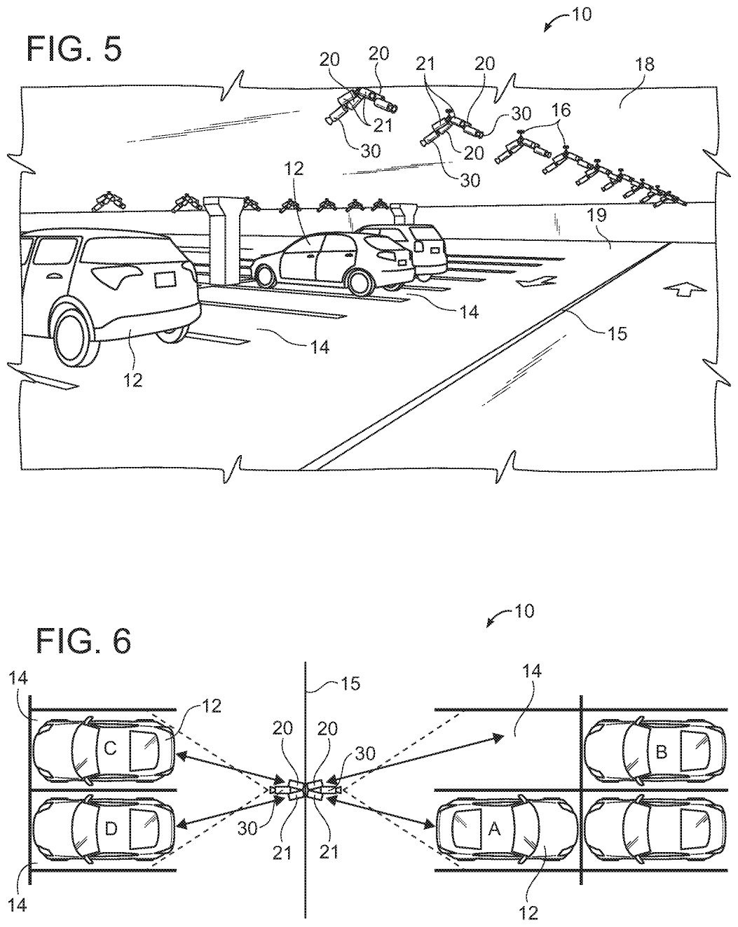

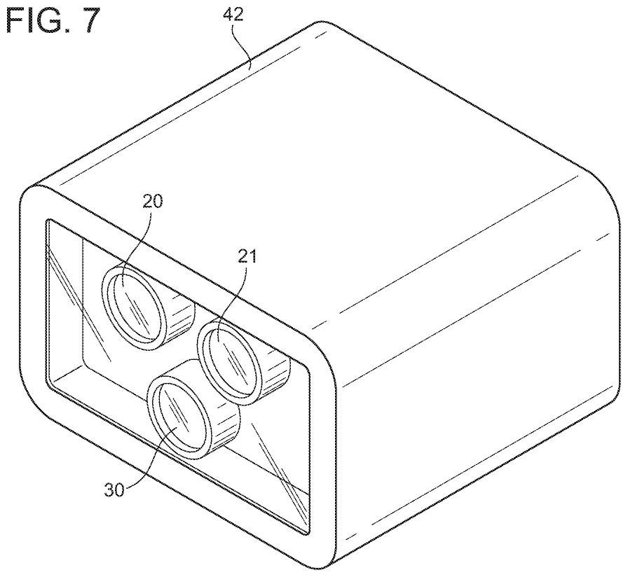

As shown throughout the figures, the vehicle license plate verification system 10 generally utilizes one or more sensors 20, 21 in combination with a camera 30 to capture identifying information, such as license plate information, of any vehicle 12 entering a point of interest. The type of sensors 20, 21 and number of sensors 20, 21 utilized may vary in different embodiments. By way of example, FIGS. 1-3 illustrate the use of a single sensor 20 in combination with a single camera 30 to monitor a point of interest comprised of a first parking space. FIGS. 4A-7, illustrate the use of a first pair of sensors 20, 21 in combination with a first camera 30 to monitor a first pair of adjacent parking spaces 14 and a second pair of sensors 20, 21 in combination with a second camera 30 to monitor a second pair of adjacent parking spaces 14.

The type of sensors 20, 21 may vary in different embodiments. By way of example and without limitation, the sensors 20, 21 may comprise light imaging, detection and ranging (LIDAR) sensors. LIDAR sensors provide high detection accuracy and also a mounting position cohesive with the mounting position of a corresponding camera 30, allowing for the potential reduction in installation infrastructure. In other embodiments, the sensors 20, 21 may comprise RF sensors or the like. In another exemplary embodiment, the systems and methods described herein may utilize the sensor arrangement of the “Vehicle Flow Monitoring System” described in U.S. patent application Ser. No. 16/750,244, which is hereby incorporated by reference.

The positioning and orientation of the sensors 20, 21 may also vary in different embodiments. Generally, the sensors 20, 21 should be positioned to be oriented towards the points of interest being monitored. In some embodiments, each point of interest will have a single sensor 20 oriented towards it. In other embodiments, multiple sensors 20, 21 may be oriented towards a single point of interest.

In a preferred embodiment as shown in the figures, the sensors 20, 21 may be positioned directly above the center-line on the parking aisle 15, oriented towards a parking space 14. Such an embodiment is shown in FIG. 1A, in which it can be seen that a sensor 20 is positioned in the center of the parking aisle 15 above the road surface on the ceiling 18, pointing angularly-downward toward a parking space. However, it should be appreciated that the sensors 20, 21 may be installed in any location that would achieve the required field of view to capture any vehicles 12 in the point of interest. In some embodiments, the sensors 20, 21 may be installed on the ground surface 19, pointing diagonally-upward toward the point of interest.

In the exemplary embodiment shown in FIGS. 1A-2, 4A, and 5, it can be seen that a mount 16 is used to secure the sensors 20, 21 to a ceiling 18 above the center of the parking aisle 15. It should be appreciated that the mounts 16 illustrated in these figures are merely for example purposes. The manner in which the sensors 20, 21 are secured to a surface, such as a ceiling 18 or the ground surface 19, may vary in different embodiments and should not be construed as limited by the figures. For example, the sensors 20, 21 could be connected to such a surface by brackets, fasteners, adhesives, poles, posts, cables, and the like.

While the figures illustrate that the sensors 20, 21 are mounted to an overhead structure such as a ceiling 18, it should be appreciated that in various situations and locations such an overhead structure may not be available. For example, outdoor parking lots or the top level of a parking garage typically do not have overhead structures such as a ceiling 18 on which to mount the sensors 20, 21. In such embodiments, the sensors 20, 21 may be mounted on their own vertical support structures, such as a post or pole as is common with street and traffic lights.

The sensors 20, 21 may be adapted to continuously take readings of the point of interest or periodically take readings. For example, the sensors 20, 21 may be configured to take readings of the point of interest only at certain time intervals, such as every five seconds. In other embodiments, the sensors 20, 21 will be “always on” so as to continuously monitor the point of interest.

The sensors 20, 21 may be communicatively connected to one or more cameras 30 such that, when one of the sensors 20, 21 detects a new vehicle in the point of interest, the relevant sensor 20, 21 (or a communicatively connected processing unit 40 as discussed below) will transmit an instruction to the camera 30 to capture an image of the point of interest. In some embodiments as discussed below and shown in FIGS. 4A-7, multiple sensors 20, 21 may be communicatively connected to a single camera 30. In such embodiments, the camera 30 may receive instructions from multiple sensors to capture images of multiple points of interest.

Thus, it should be appreciated that the field of view of a single camera 30 may cover the detection radii of multiple sensors 20, 21. Although the figures illustrate embodiments comprising two sensors 20, 21 per camera 30, additional sensors 20, 21 may be assigned to each camera 30 in alternate embodiments. For example, a camera 30 having a particularly wide field of view or positioned a sufficient distance away may be configured to capture images of an entire row of parking spaces 14.

The manner in which the sensors 20, 21 are communicatively connected to the camera 30 may vary in different embodiments. In some embodiments, a wired connection such as a serial or parallel connection may be used to connect each sensor 20, 21 to a camera 30. In other embodiments such as shown in the figures, the sensors 20, 21 may be wirelessly connected to the camera 30, such as by Bluetooth, RF, the Internet, or other communications protocols.

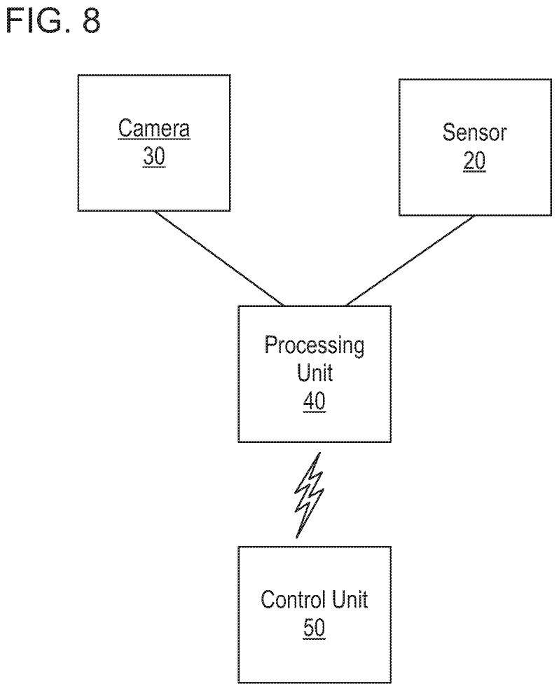

In other embodiments, the sensors 20, 21 may be communicatively connected to a processing unit 40 such as shown in FIG. 8. In such an embodiment, the processing unit 40 is communicatively connected to each of the sensors 20, 21 and each of the cameras 30 of the system 10, with the processing unit 40 processing all data and managing both the detection of vehicles 12 by the sensors 20, 21 and the image capture of those vehicles 12 by the cameras 30.

### C. Cameras.

As shown throughout the figures, the system 10 may utilize one or more cameras 30 to capture images of any vehicles 12 in the point of interest being monitored by the sensors 20, 21. Various types of cameras 30 may be utilized, including cameras 30 with video and/or audio capabilities. The cameras 30 may be configured to continuously capture images or only periodically capture images. In a preferred embodiment, the cameras 30 are configured to capture images when (1) a sensor 20, 21 indicates presence of a vehicle 12 in the point of interest or (2) when a previously captured image was processed and the license plate image or data of the vehicle 12 was not identifiable or otherwise not successfully extracted.

The number of cameras 30 utilized for each point of interest may vary in different embodiments. Further, the number of cameras 30 used per sensor 20, 21 may also vary in different embodiments. FIGS. 1A and 1B illustrate a single point of interest being monitored by a single camera 30 in connection with a single sensor 20. However, due to the difference in fields of view of the camera 30 as compared to the sensors 20, 21, it is possible in some embodiments that a single camera 30 may monitor multiple points of interest, with each of the points of interest being monitored by a separate sensor 20, 21.

FIG. 4B illustrates a pair of points of interests comprised of a pair of adjacent parking spaces 14 being monitored by a single camera 30 in connection with a pair of sensors 20, 21. Such a configuration is viable because the field of view of the camera 30 will typically be wider than the field of view of a sensor 20, 21 as illustrated in the figure. An example of this configuration is shown in FIGS. 4A, 4B, and 6, in which it can be seen that a first point of interest comprised of a first parking space 14 is monitored by a first sensor 20 and a second point of interest comprised of a second parking space 14 is monitored by a second sensor 21, with the camera 30 having a field of view which is wide enough to cover both points of interest. In such an embodiment, both sensors 20, 21 may be communicatively connected to the camera 30, either directly or through a processing unit 40.

The positioning and orientation of the camera 30 may also vary in different embodiments. Generally, the camera 30 should be positioned and oriented towards the points of interest being monitored such that the points of interest are within the field of view of the camera 30. In some embodiments, each point of interest will have a single camera 30 oriented towards it. In other embodiments, multiple cameras 30 may be oriented towards a single point of interest. In yet further embodiments, multiple points of interest may be covered by a single camera 30 such as shown in FIG. 6. Further, in some embodiments, multiple cameras 30 may have overlapping fields of view. In such embodiments, a single point of interest may be monitored from different angles by each of a plurality of cameras 30.

In a preferred embodiment as shown in the figures, the camera 30 may be positioned directly above the center-line on the parking aisle 15, oriented towards a parking space 14. Such an embodiment is shown in FIG. 1A, in which it can be seen that a camera 30 is positioned in the center of the parking aisle 15 above the road surface, pointing angularly-downward toward a parking space 14. However, it should be appreciated that the camera 30 may be installed in any location that would achieve the required field of view to capture any vehicles 12 in the point of interest. In some embodiments, the camera 30 may be installed on or near the ground or road surface 19, pointing diagonally-upward toward the point of interest.

In the exemplary embodiment shown in FIGS. 1A-2, 4A, and 5, it can be seen that a mount 16 is used to secure the camera 30 to a ceiling 18 above the center of the parking aisle 15. It should be appreciated that the mounts 16 illustrated in these figures are merely for example purposes. The manner in which the cameras 30 are secured to a surface, such as a ceiling 18 or the ground surface 19, may vary in different embodiments and should not be construed as limited by the figures. For example, the cameras 30 could be connected to such a surface by brackets, fasteners, adhesives, poles, posts, cables, and the like.

While the figures illustrate that the camera 30 is mounted to an overhead structure such as a ceiling 18, it should be appreciated that in various situations and locations such an overhead structure may not be available. For example, outdoor parking lots or the top level of a parking garage typically do not have overhead structures such as a ceiling 18 on which to mount the camera 30. In such embodiments, the camera 30 may be mounted on their own vertical support structures, such as a post or pole as is common with street and traffic lights.

The camera 30 may be positioned adjacent to one or more sensors 20, 21 such as shown in the figures. In such embodiments, the camera 30 may be directly connected to, or even integrated with, the sensors 20, 21. In a wired connection, the camera 30 may be connected to the sensors 20, 21 by a hardwired serial or parallel communication or the like.

In other embodiments, the camera 30 may be wirelessly connected to one or more sensors 20, 21, such as by Bluetooth, WiFi, RF, or the like. In such embodiments, the camera 30 may be positioned at a location which is distant with respect to the sensors 20, 21. For example, in some embodiments, the camera 30 could be positioned overhead and the sensor 20 could be positioned on the ground surface 19, with both the sensor 20 and the camera 30 being oriented towards the same point of interest.

While both the sensor 20 and camera 30 are preferably oriented towards the same point of interest, they are not necessarily oriented at the same angle or even in the same direction. For example, in some embodiments, the camera 30 could be positioned in front of a parking space 14 to capture a front license plate and the sensor 20 could be positioned over a center aisle 15 behind the parking space 14. In such an embodiment, the camera 30 and sensor 20 would be oriented in opposite directions while still maintaining the same point of interest in the field of view.

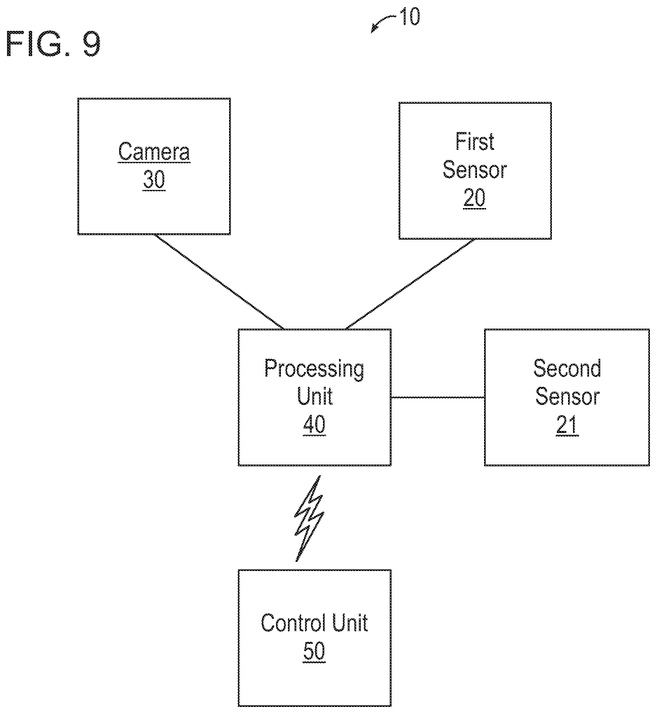

In some embodiments, the camera 30 may not be directly communicatively connected to the sensors 20, 21. In such embodiments, the camera 30 may be communicatively connected to the processing unit 40, with the processing unit 40 also being communicatively connected to the sensors 20, 21 such as shown in FIGS. 8 and 9.

### D. Processing Unit.

As shown throughout the figures, exemplary embodiments of the system 10 may comprise a processing unit 40 which is communicatively connected to the camera 30 and to any sensors 20, 21 associated with that camera 30. The processing unit 40 may be configured to perform the necessary functions to process the images which are captured by the camera 30. In some embodiments, the processing unit 40 may function as a gateway between the camera 30 and any associated sensors 20, 21 so as to both process the data from the sensors 20, 21 to detect when a new vehicle 12 has arrived and to instruct the camera 30, such as through a control signal or instruction, to capture an image of the point of interest such as a parking space 14 when such a new vehicle 12 is detected by the sensors 20, 21.

By way of example, the processing unit 40 may be configured to extract a license plate image or data relating to a license plate from a captured image of a vehicle 12 positioned at or near a point of interest such as a parking space 14. In some embodiments, the actual image of the license plate may be extracted. In other embodiments, the processing unit 40 (or control unit 50 as discussed below) may instead or additionally extract data from the image, such as extracting letters and numbers via object character recognition. Such extracted data may be utilized to maintain a database of occupied points of interest along with identifying information such as a vehicle license plate number without requiring the storage of the actual captured images. The processing unit 40 may also be configured to detect when a license plate image cannot be extracted from a particular image captured by the camera 30 and to, in those cases, instruct the camera 30 to capture additional images of the vehicle 12 until a license plate image can be extracted.

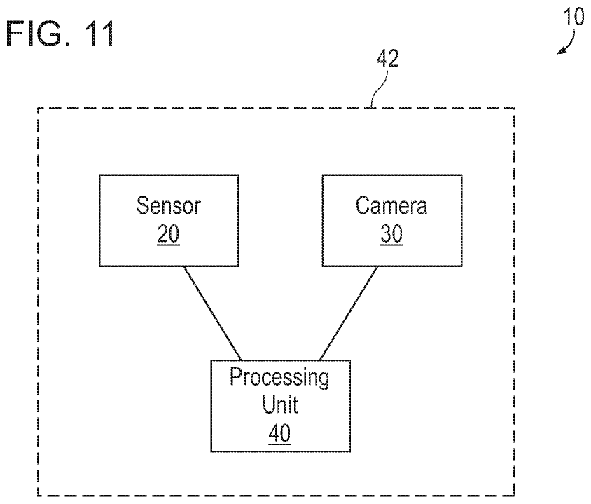

The processing unit 40 may comprise various computing devices and systems, such as by way of example a microcontroller or microprocessor. The processing unit 40 may comprise memory on which data, such as captured images of vehicles 12 or extracted license plate images, may be stored. The processing unit 40 may be positioned in the same housing 42 as the sensors 20, 21 and/or camera 30 such as shown in FIG. 11, or may be housed separately. In embodiments in which the processing unit 40 is remotely positioned with respect to one or more sensors 20, 21 and/or cameras 30, the processing unit 40 may be wirelessly connected to the sensors 20, 21 and/or camera 30 that are remotely positioned.

The processing unit 40 may be communicatively connected to a large number of sensors 20, 21 and/or cameras 30. In some embodiments, the processing unit 40 may be communicatively connected to additional processing units 40 which are themselves communicatively connected to additional sensors 20, 21 and/or cameras 30. Such a distributed network of processing units 40, cameras 30, and sensors 20, 21 may be utilized to cover a large area, such as a large, multi-story parking garage. In such an embodiment, there may be a combination of ceiling-mounted, ground-mounted, pole-mounted, or otherwise mounted sensors 20, 21, cameras 30, and/or processing units 40. As discussed below, a central control unit 50 may be communicatively connected to such a distributed network of processing units 40, cameras 30, and sensors 20, 21 to manage and process the data from the entire network.

The manner in which the processing unit 40 is connected to the sensors 20, 21, cameras 30, additional processing units 40, and/or a control unit 50 may vary. For example, the processing unit 40 may be connected by a wired connection to a sensor 20 and a camera 30, and by a wireless connection to additional processing units 40 and/or a control unit 50. In other embodiments, the processing unit 40 may standalone and be wirelessly connected to the sensors 20, 21 and cameras 30 as well.

### E. Control Unit.

As shown in FIGS. 8-10, a central control unit 50 may be utilized to collect, analyze, process, and/or display the information of a plurality of cameras 30 covering a plurality of points of interest such as parking spaces 14. Such a configuration may be desirable on large parking lots, parking garages, street parking areas, and the like.

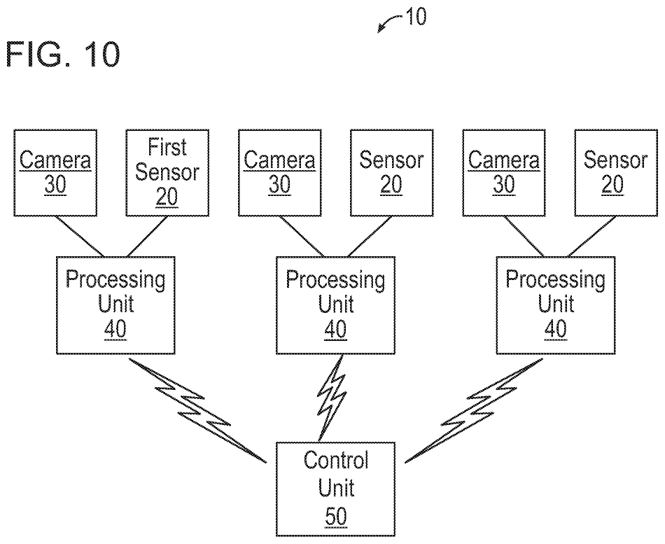

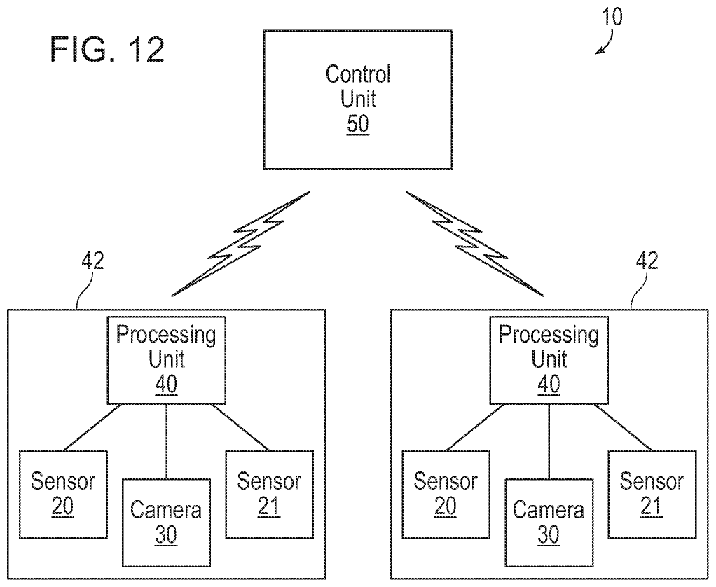

As shown in FIGS. 10 and 12, the control unit 50 may be communicatively connected to a plurality of sensors 20, 21, cameras 30, or processing units 40. In some embodiments, the sensors 20, 21 and cameras 30 may be directly communicatively connected to the control unit 50, such as by a wireless connection. In other embodiments, the processing unit 40 associated with each sensor 20, 21 and camera 30 will be directly communicatively connected to the control unit 50, with the sensors 20, 21 and cameras 30 not being directly connected to the control unit 50. In either case, data and captured images may be transferred to the control unit 50 for processing and storage.

The control unit 50 may comprise various types of devices and systems capable of storing, processing, transmitting, and receiving data and images from the sensors 20, 21, cameras 22, and/or processing units 30 of the system 10. In this manner, a large number of points of interest, such as parking spaces 14, may be monitored in real-time by the control unit 50 based on the data and images received from the other components of the system 10.

The control unit 50 may, for example and without limitation, comprise a computer system such as a server computer, desktop computer, laptop computer, tablet computer, or mobile computer such as a smart phone. The control unit 50 may also comprise multiple such computer systems which are interconnected to form a distributed network. In some embodiments, the functions of the control unit 50, including but not limited to storage and processing of data and images, may be performed across multiple computer systems. In some embodiments, the data and images may be stored on and/or accessed from the cloud.

### F. Operation of Exemplary Embodiments.

The systems and methods described herein may be utilized for a wide range of situations involving the monitoring of a point of interest. While the figures illustrate points of interest comprised of parking spaces 14 and objects being detected as vehicles 12, it should be appreciated that different points of interest and different types of objects could be supported by the methods and systems described herein. For example, in some embodiments, boat slips could be monitored, with the camera 30 being configured to photograph and extract an image of the boat's name or identification number. In yet other embodiments, aircraft hangars could be monitored, with the camera 30 being configured to photograph and extract an image of the aircraft's tail with its identification number.

FIGS. 1A-3 illustrate a first embodiment of an exemplary vehicle identification system 10. In such an embodiment, a single point of interest comprised of a parking space 14 is monitored by a single sensor 20 and a single camera 30. In the embodiment shown in FIGS. 1A and 1B, the sensor 20 and camera 30 are each shown as being positioned directly above the center aisle 15 and oriented at a downward angle towards a point of interest. As can be seen, the sensor 20 is oriented so as to detect an object such as a vehicle 12 entering the point of interest. The camera 30 is oriented so that its field of view will capture an image of an identifying feature of the vehicle 12 which, in this case, is a rear or front license plate, depending on how the vehicle 12 is parked.

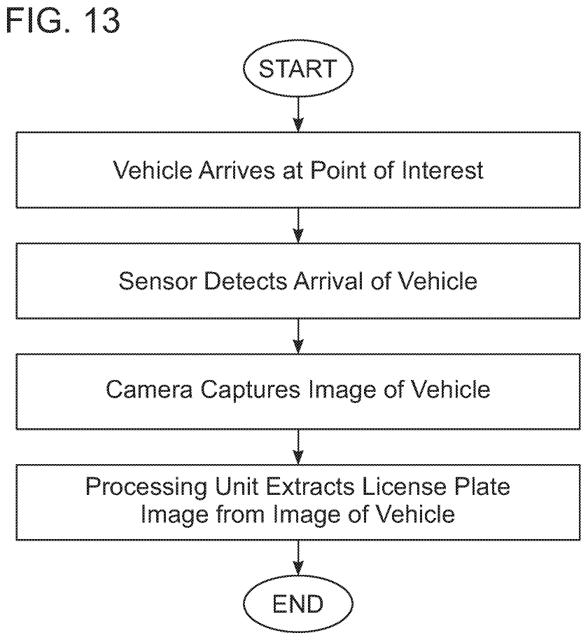

FIG. 13 illustrates the overall method of identifying the vehicle 12 in FIG. 1A. The sensor 20 is configured to continuously monitor the point of interest to determine when an object such as a vehicle 12 has entered the point of interest. The manner in which the sensor 20 detects the vehicle 12 may vary in different embodiments, including the use of LIDAR sensing. Upon arrival of the vehicle 12 in the point of interest, the sensor 20 device will detect a new vehicle 12 at the point of interest.

Upon detection of the vehicle 12 at the point of interest, the camera 30 will be instructed to capture an image of the vehicle 12. The manner in which the camera 30 is instructed to capture the image of the vehicle 12 may vary in different embodiments. In an exemplary embodiment, a processing unit 40 may direct the camera 30 to capture an image of the vehicle 12 upon detection by the sensor 30 by, for example, activating a subroutine. An image of the vehicle 12 is then captured by the camera 30.

Upon the capture of an image of an object such as a vehicle 12, the image will be processed to extract an image of an identifying feature of the object, such as in the case of a vehicle 12 the license plate. In other embodiments, the image of the vehicle 12 may be transferred offsite, such as a cloud based control unit 50, for data processing and image extraction. Thus, either the processing unit 40 may extract the image of the identifying feature itself, or the image may be transferred to the control unit 50 for extraction.

Upon extraction of an identifying feature from the image, various data may be transferred to the control unit 50 to be saved in memory or processed further. By way of example and without limitation, such data as the captured image of the identifying feature, data representing the captured image of the identifying feature, data identifying the specific point of interest that the image was captured at, specific bay identifiers, timestamps, sensor 20, 21 identification, camera 30 identification, processing unit 40 identification, location, temperature, status of other points of interest at that time, and other data may be received by the control unit 50. In this manner, the control unit 50 may maintain a database of which points of interest are occupied by an object that is continuously updated in real-time.

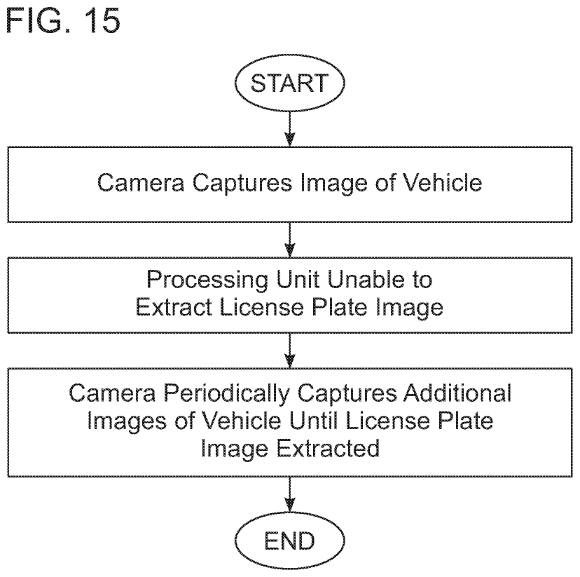

In some circumstances, it may not be possible to extract an identifying feature from a captured image. For example, if there is glare from the sun or a person walking by, the image of a license plate of a vehicle 12 may be obstructed or obscured. In such cases, the processing unit 40 and/or control unit 50, upon detecting that an identifying feature is not extractable from the captured image, may continue to instruct the camera 30 to capture periodic additional images in an attempt to capture an image from which an identifying feature may be extracted such as shown in FIG. 15.

If the vehicle 12 is detected by the sensors 20, 21 as having departed the point of interest, the camera 30 may stop capturing images until a new vehicle 12 has entered the point of interest. Further, the camera 30 will stop capturing images upon the processing unit 40 and/or control unit 50 successfully extracting an identifying feature from one of the additional captured images. In some embodiments, the system 10 may be configured such that, after a set period of time or a set number of failed extractions, the camera 30 will stop capturing images of the point of interest until the vehicle 12 has left and been replaced by a new vehicle 12.

In cases in which an identifying feature such as a license plate of a vehicle 12 is not recognized, the point of interest will still be considered as “occupied” by the processing unit 40 and/or control unit 50 until such time as the sensors 20, 21 detect the departure of the vehicle 12. Further, any applications involving parking guidance (such as directing vehicles 12 to a specific parking space 14) or space availability notifications will still be accurate. However, in situations in which a parking space 14 is reserved, the system 10 may trigger an alarm indicating that the processing unit 40 and/or control unit 50 is unable to verify that the vehicle 12 inhabiting the parking space 14 is authorized. In such instances, the system 10 may, for example, direct an attendant to manually confirm the identity of the vehicle 12 positioned in the parking space 14.

FIGS. 4A and 4B illustrate an embodiment in which multiple points of interest are monitored by multiple sensors 20, 21 and cameras 30. In the embodiment shown in FIGS. 4B and 6, it can be seen that there are four points of interest comprised of four parking spaces 14. A first camera 30 is directed toward a first pair of parking spaces 14, with the field of view of the first camera 30 being sufficient to capture images of both parking spaces 14. A pair of sensors 20, 21 are associated with that camera 30, with the first sensor 20 being oriented to detect the first parking space 14 and the second sensor 21 being oriented to detect the second parking space 14.

Continuing to reference FIGS. 4B and 6, it can be seen that a second pair of parking spaces 14 are positioned on the other side of a center aisle 15 opposite the first pair. These parking spaces 14 are monitored by a second camera 30 and a second pair of sensors 20, 21, with the second camera 30 being oriented such that its field of view encompasses both of the second pair of parking spaces 14. A first sensor 20 is oriented toward the first of the second pair of parking spaces 14 and a second sensor 21 is oriented toward the second of the second pair of parking spaces 14.

While the example embodiments in FIGS. 1A, 1B, 2, and 4A—6 do not illustrate the processing units 40, it should be appreciated that the sensors 20, 21 and cameras 30 shown in these figures may be communicatively connected to one or more processing units 40, either wirelessly or through a wired connection. For example, a housing 42 may be provided in which the sensors 20, 21, cameras 30, and processing units 40 may be housed. By way of example, a first housing 42 could house the first camera 30 and first pair of sensors 20, 21 and a second housing 42 could house the second camera 30 and second pair of sensors 20, 21. In other embodiments, a single housing 42 could house all of the cameras 30 and sensors 20, 21 shown in FIGS. 4A, 4B, and 6.

The detection of multiple points of interest having multiple objects with identifying features to be extracted utilizes a similar method as with a single point of interest. However, some additional steps may need to be performed to ensure reliability where multiple objects such as vehicles 12 may be within the field of view of the cameras 30.

As can be seen in FIG. 6, multiple parking spaces 14 may be captured by a single camera 30. In such an embodiment, the camera 30 may receive notification that multiple sensors 20, 21 have detected a vehicle 12. Preferably, the system 10 will account for such situations by associating each sensor 20, 21 with a specific point of interest and a specific camera 30. In such a manner, the system 10 will know which point of interest is being detected by which sensor 30, and thus which portion of a captured image from the camera 30 to extract the identifying feature such as a license plate from. Such an association may be accomplished by, for example, having a hard-wired connection between all corresponding sensors 20, 21 and cameras 30. In other embodiments, the location and orientation of each sensor 20, 21 may be stored in memory so that each time a sensor 20, 21 detects an object, the system 10 knows which point of interest that particular sensor 20, 21 was oriented towards. In other embodiments, the camera 30 may be adapted to store the identifier of the sensor 20, 21 which triggered for image association with the appropriate parking space 14 for further analysis.

As an example, FIG. 6 illustrates multiple parking spaces 14 which are covered by a pair of cameras 30, each having been associated with a pair of sensors 20, 21. In the embodiment shown in FIG. 6, it can be seen that the parking spaces 14 on the right side are two-cars deep. For example, a camera 30 obtaining an image of the vehicle 12 identified as A may pick up the front license plate of the vehicle 12 identified as B in the same captured image. In such a circumstance, it is important that the system 10 be able to differentiate the valid license plate of the vehicle 12 identified as A from the license plate of the vehicle 12 identified as B.

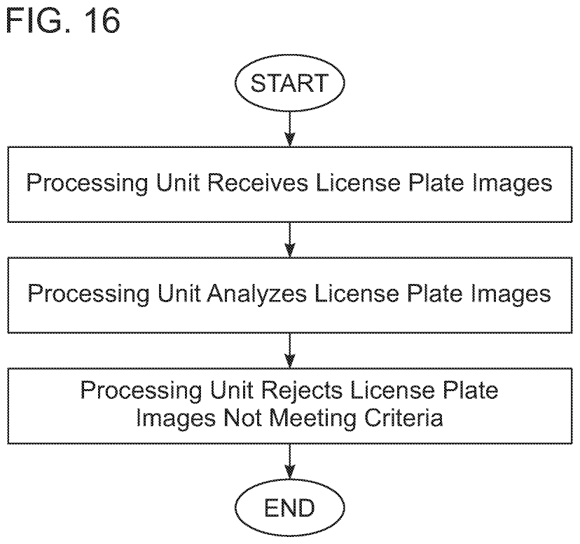

One method for distinguishing valid license plate images from invalid license plate images is shown in FIG. 16. The system 10 may utilize certain criteria to verify or validate that the license plate image is actually in the point of interest being monitored, rather than a separate, adjacent point of interest such as is the case with the vehicles 12 shown in FIG. 6 as A and B. One such criterion may be the size of the license plate in the extracted image. The system 10 may be configured to accept a certain range of image sizes as representative of a license plate in the point of interest being monitored. License plates that are too far away from the point of interest would be smaller than the range of acceptable image sizes and thus be rejected. License plates that are too close to the point of interest would be larger than the range of acceptable image sizes and thus similarly be rejected.

In another embodiment, the criteria may be based on the location and orientation of the camera 30 and point of interest. In such an embodiment, the field of view 30 of the camera 30 may be partitioned internally between the points of interest being monitored by the camera 30. For example, a camera 30 covering a first parking space 14 with a first half of its field of view and a second parking space 14 with a second half of its field of view would associate a license plate with the point of interest based on the location of the license plate within the camera's 30 field of view. Any license plates outside of the expected partitions of the field of view may be rejected.

Continuing to reference FIG. 6, there may be situations where two vehicles 12 parking in adjacent parking spaces 14 at the same time. It is important in those situations that the system 10 is able to identify and differentiate the two vehicles 12 so that each vehicle 12 may be associated with its actual parking space 14. For example, if the vehicles 12 identified as C and D should happen to arrive at the same time, they might both be captured in a subsequent image capture by the camera 30. One method of differentiating the vehicles 12 is discussed above, in which an image region or polygon may be set for the field of view of the camera 30 so that the system 10 knows which parking space 14 each captured license plate is in. However, such a configuration may be undesirable in some circumstances, such as where cameras 30 or sensors 20, 21 are suspended in an open structure and subject to movement by wind or other forces. In such circumstances, the field of view of the camera 30 may be dynamic depending on the movement of the camera 30.

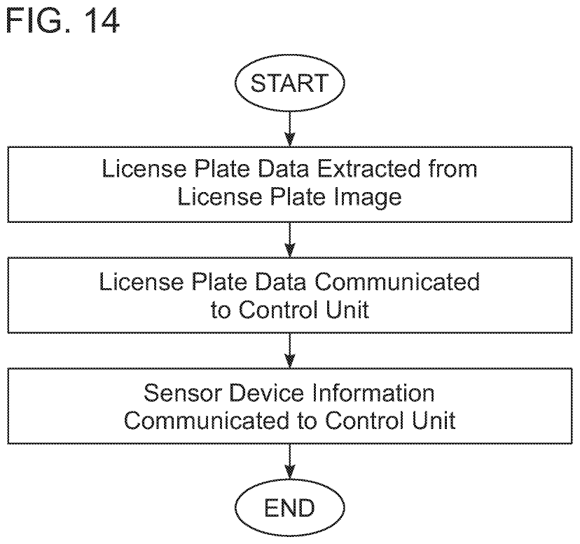

As shown in FIG. 14, data relating to extracted identifying features may be stored on the control unit 50, such as a cloud-based server, for use as appropriate. All details of all identifying features, such as license plates, may be sent to the control unit 50 for further analysis and application of logic to reduce or eliminate errors. License plate data communicated with the control unit 50 may thus include information identifying the sensor 20, 21 which detected the vehicle 12 from which the license plate data was extracted. For example, such information may include a specific bay identifier identifying the parking space 14 being occupied, timestamps indicating the time and date that the image was captured, and hardware identifiers such as a MAC address for the sensor 20, 21 and/or camera 30 involved in the capture and extraction of the license plate data.

Such information may be communicated to the control unit 50 in a number of manners, including but not limited to communication by the camera 30, the sensors 20, 21, both cameras 30 and sensors 20, 21, or the processing unit 40. The transfer of this information may be direct or via an appropriate communication gateway, such as the Internet. In some embodiments, all data, information, and details of all license plates that were recognized within a captured image may be sent to the control unit 50 for further processing and analysis, even if the total number of license plates recognized goes beyond the scope of the associated parking spaces 14. In this manner, the control unit 50 may be relied upon for quality control and verification.

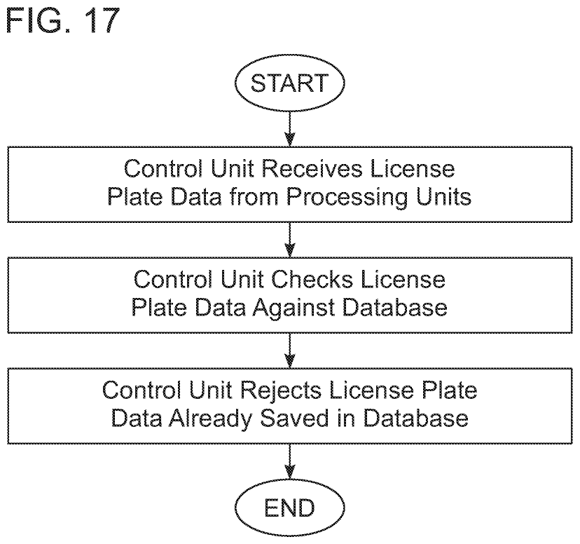

FIG. 17 illustrates a method of differentiating newly-arrived vehicles 12 from vehicles 12 which were already detected and identified. By way of example, with reference to FIG. 6, there could be a scenario where the vehicle 12 identified as C first arrives in a first parking space 14. The sensor 20 detects the vehicle 12 and the camera 30 captures an image of the vehicle 12. The license plate data is extracted from the captured image of the vehicle 12 and associated with that particular parking space 14 in the memory of the control unit 50 until such as time as the vehicle 12 leaves.

Subsequently, when the vehicle 12 identified as D arrives and parks next to the vehicle 12 identified as C, the sensor 21 will detect the newly-arrived vehicle 12 and the camera 30 will capture an image. In this case, both of the vehicles 12 identified as C and D would be within the field of view of the camera 30, and thus both license plates would be present in the captured image. Upon receipt of the new captured image, the control unit 50 will compare the two license plates extracted from the captured image with the database of license plates stored in memory.

The control unit 50 will recognize that the vehicle 12 identified as C was already in the memory, and thus the control unit 50 can eliminate the license plate data associated with the vehicle 12 identified as C as it has already been taken and associated with the parking space that vehicle 12 is occupying. Therefore, the other license plate from the captured image, which is representative of the vehicle 12 identified as D, will be saved to memory and associated with the appropriate parking space 14. In this manner, the system 10 will correctly identify that there are two unique vehicles 12 within the two parking spaces 14 without duplication.

These steps may be performed repeatedly. Whenever a new license plate is extracted from a captured image, that license plate will be compared to other license plates in memory so as to eliminate duplicate entries. In circumstances in which the system 10 is unable to verify the positioning of the vehicles 12 for one reason or another, the system 10 may simply record both license plates as being “in the area” without identifying a particular parking space 14. Such a configuration may still be useful for monitoring the number of parking spaces 14 available in an area, since the specific occupied spaces 14 need not be known for a simple count of available spaces 14. In other embodiments, the system 10 may simply randomly associate the license plates with a particular parking space 14.

At a later point in time, if the vehicle 12 identified as D were to leave and be replaced by another vehicle 12, another captured image will be transferred to the control unit 50 for processing. The control unit 50 will recognize that the second parking space 14 has been occupied by a new vehicle 12; with the vehicle 12 identified as C remaining in the first parking space 14. The control unit 50 may then correct the association as necessary. The vehicle 12 identified as C is still present, but the system 10 recognizes that license plate as already being in memory, and thus is able to associate the newly-arrived vehicle 12 with the appropriate parking space 14.

In a further embodiment, personal information of an extracted license plate within a captured image may be communicated to the control unit 50 for further processing and analysis. Continuing to reference the vehicles 12 identified as C and D in FIG. 6, the vehicle 12 identified as D will be captured in the left of the captured image, with the vehicle 12 identified as C being more to the right of the field of view. If the system 10 has any confusion about the positioning of the two vehicles 12, the control unit 50 may reason that the license plate with the left-most position is that of the vehicle 12 identified as Din the left parking space 14.

When only a single vehicle 12 is communicated for occupation of a singular space 14, the system 10 may record this as a valid license plate position for that space 14. Similarly, when a second vehicle 12 arrives subsequently and then only two license plate details are communicated, the second plate position can also be recorded as a valid position for the second parking space 14. In this manner, a position map may be formed of valid positions for license plates for a given parking space 14. This creates a learned region for the license plate position of a parking space 14 as opposed to a manually-defined region configured upon installation. In other words, through use, the system 10 will eventually learn to partition fields of views between parking spaces 14. This information can be used in times of uncertainty. For example, if there is a singular license plate within a learned region (or close to such a region), that license plate may be associated with confidence to that region's parking space 14.

In some embodiments, data related to a large number of points of interest such as parking spaces 14 may be stored and processed on a control unit 50. For example, in a large parking garage, the control unit 50 may process data from the cameras 30 and sensors 20, 21 to create a dynamic display which shows the occupancy or vacancy of each of the parking spaces 14 in the parking garage. This display may be visible by an attendant to manage the parking garage. The display may include identifying information of each vehicle 12 parked in a parking space 14, such as a license plate number, or may indicate a lack of such information when there has been a failure in extraction or processing.

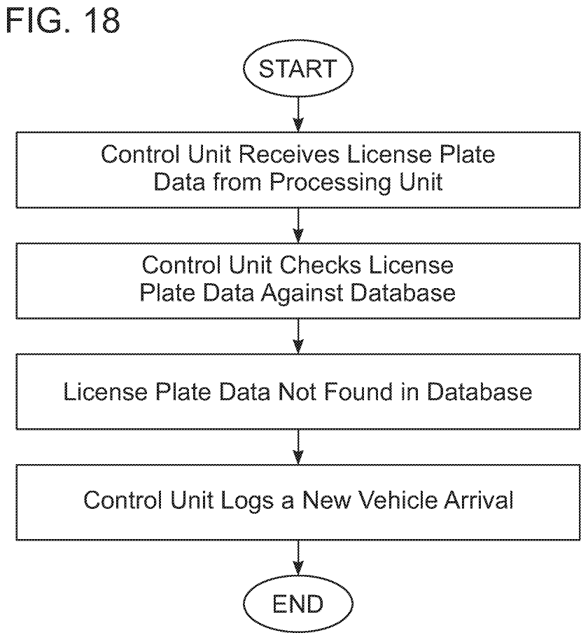

FIG. 18 illustrates the use of data within the database to detect when a new vehicle 12 has arrived. Anytime the control unit 50 receives license plate data from a processing unit 40, the control unit 50 will check the license plate data against the database. If the license plate is not found in the database, the control unit 50 will log a new vehicle 12 arrival. If the license plate is found in the database, the control unit 50 will recognize that it is not a newly-arrived vehicle 12 and process accordingly, such as by rejecting the license plate data as shown in FIG. 17.

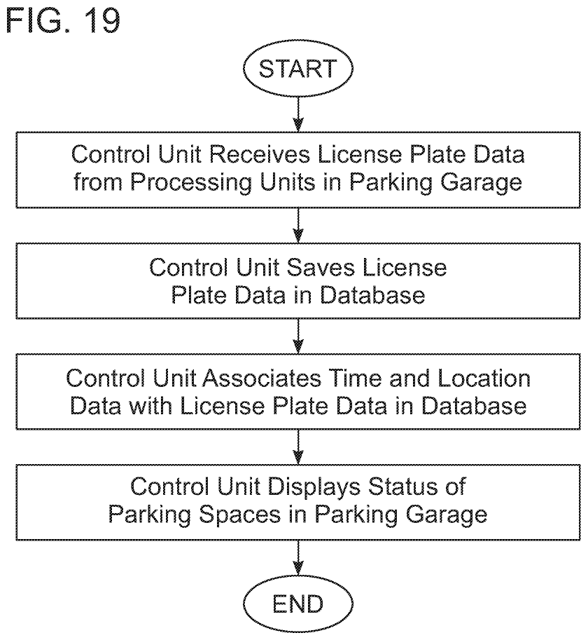

FIG. 19 illustrates an exemplary method for displaying the status of parking spaces 14 in a parking garage. A control unit 50 receives license plate data, which may comprise actual images or simply data such as license plate numbers, from processing units 40 within a parking garage. All newly-arriving license plate data is saved in a database which may be internal to the control unit 50 or may be on the cloud. The control unit 50 associates a time and location data with the license plate data in the database. Using this information, the control unit 50 displays the status of the parking spaces 14 in the parking garage.

Unless otherwise defined, all technical and scientific terms used herein have the same meaning as commonly understood by one of ordinary skill in the art to which this invention belongs. Although methods and materials similar to or equivalent to those described herein can be used in the practice or testing of the vehicle identification system, suitable methods and materials are described above. All publications, patent applications, patents, and other references mentioned herein are incorporated by reference in their entirety to the extent allowed by applicable law and regulations. The vehicle identification system may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

1. A vehicle identification system, comprising:
a sensor oriented towards a point of interest, wherein the sensor is configured to detect a vehicle positioned at or near the point of interest;
a camera oriented such that the point of interest is within a field of view of the camera, wherein the camera is configured to capture an image of the vehicle when the sensor detects the vehicle positioned at or near the point of interest; and
a processing unit communicatively connected to the camera and the sensor, wherein the processing unit is configured to extract license plate data from the image of the vehicle, wherein the processing unit is configured to reject the license plate data and instruct the camera to capture an additional image of the vehicle if the license plate data is not extracted from the image of the vehicle, wherein the processing unit is configured to determine if the vehicle is positioned at or near the point of interest based on a size of a license plate image of the license plate data.

2. The vehicle identification system of claim 1, further comprising a housing for housing the sensor, the camera, and the processing unit.

3. The vehicle identification system of claim 1, wherein the sensor is comprised of a LIDAR sensor.

4. The vehicle identification system of claim 1, wherein the point of interest is a parking space.

5. The vehicle identification system of claim 1, wherein the license plate data comprises an image of a license plate of the vehicle.

6. The vehicle identification system of claim 5, wherein the processing unit is configured to determine if the vehicle is parked in the point of interest based on a position of the license plate in the image of the license plate.

7. (canceled)

8. The vehicle identification system of claim 1, further comprising a control unit communicatively connected to the processing unit.

9. The vehicle identification system of claim 8, wherein the control unit is remote with respect to the processing unit.

10. The vehicle identification system of claim 8, wherein the control unit comprises a memory, wherein the processing unit is configured to communicate the license plate data to the control unit, wherein the control unit is configured to save the license plate data to the memory of the control unit.

11. The vehicle identification system of claim 10, wherein the control unit is configured to identify the vehicle as a new vehicle if the license plate image does not match any of a plurality of reference images.

12. The vehicle identification system of claim 1, wherein the license plate data comprises a license plate number.

13. A method of monitoring a parking space with the vehicle identification system of claim 1, comprising the steps of:
detecting the vehicle positioned at or near the point of interest by the sensor;
capturing the image of the vehicle by the camera when the sensor detects the vehicle positioned at or near the point of interest;
extracting license plate data from the image of the vehicle by the processing unit; and
verifying the license plate data based on one or more criteria by the processing unit.

14. The method of claim 13, wherein the license plate data comprises an identification of the sensor which detected the vehicle.

15. (canceled)

16. A vehicle identification system, comprising:
a first sensor oriented towards a first point of interest, wherein the first sensor is configured to detect a first vehicle positioned at or near the first point of interest;
a second sensor oriented towards a second point of interest, wherein the second sensor is configured to detect a second vehicle positioned at or near the second point of interest;
a camera oriented such that both the first point of interest and the second point of interest are within a field of view of the camera, wherein the camera is configured to capture an image of the first vehicle when the first sensor detects the first vehicle positioned at or near the first point of interest, wherein the camera is configured to capture an image of the second vehicle when the second sensor detects the second vehicle positioned at or near the second point of interest; and
a processing unit communicatively connected to the first sensor, the second sensor, and the camera, wherein the processing unit is configured to extract a first license plate image from the image of the first vehicle and a second license plate image from the image of the second vehicle, wherein the processing unit is configured to verify that the first vehicle is positioned at or near the first point of interest based on a size of a first license plate image in the image of the first vehicle, and wherein the processing unit is configured to verify that the second vehicle is positioned at or near the second point of interest based on a size of a second license plate in the image of the second vehicle.

17. The vehicle identification system of claim 16, wherein the first sensor is positioned adjacent to the second sensor.

18. The vehicle identification system of claim 16, wherein the first sensor, the second sensor, and the camera are each angled downwardly.

19. The vehicle identification system of claim 16, comprising a housing for housing the processing unit, the first sensor, the second sensor, and the camera.

20. A vehicle identification system, comprising:
a plurality of sensors each being oriented towards at least one of a plurality of points of interest;
a plurality of cameras each being oriented towards at least one of the plurality of points of interest, wherein at least one of the plurality of cameras and at least one of the plurality of sensors is oriented towards each of the plurality of points of interest;
a plurality of processing units, wherein at least one of the plurality of processing units is communicatively connected to at least one of the plurality of sensors and at least one of the plurality of cameras; and
a control unit communicatively connected to each of the plurality of processing units;
wherein each of the plurality of sensors is configured to detect a vehicle positioned at or near at least one of the plurality of points of interest;
wherein each of the plurality of cameras is configured to obtain an image of the vehicle when one of the plurality of sensors detects the vehicle positioned at or near at least one of the plurality of points of interest;
wherein each of the plurality of processing units is configured to extract a license plate image from the image of the vehicle, wherein each of the plurality of processing units is configured to transfer the license plate image of the vehicle to the control unit, wherein the control unit is configured to associate the license plate image of the vehicle with one of the plurality of points of interest, and wherein each of the plurality of processing units is configured to verify a position of the vehicle based on a size of the license plate image of the vehicle.
